(19) United States
(12) Patent Application Publication
(10) Pub. No.: US 2002/0003088 A1
(43) Pub. Date: Jan. 10, 2002

(54) Method of producing improved sealing structure of gas sensor

(75) Inventor: Masato Ozawa, Toyota-shi (JP)

Correspondence Address: Pillsbury Winthrop LLP, Intellectual Property Group, East Tower, Ninth Floor, 1100 New York Avenue, N.W., Washington, DC, 20005-3918, US

(73) Assignee: DENSO CORPORATION, Kariya-city (JP)

(21) Appl. No.: 09/900,889

(22) Filed: Jul. 10, 2001

(30) Foreign Application Priority Data
Jul. 10, 2000 (JP) 2000-208127
Apr. 27, 2001 (JP) 2000-133133

(51) Int. Cl. G01N 27/417

(52) U.S. Cl. 204/424

(57) ABSTRACT

A method of producing an improved housing structure of a gas sensor designed to provide a hermetic seal which keeps a reference gas chamber and a gas chamber airtight. A housing is made by cold forging using lubricant. In order to provide a smooth surface to an inner wall of the housing which is required to establish the hermetic seal, the lubricant is removed using alkali and acid, or by machining or polishing the inner wall of the housing after the cold forging. Alternatively, the inner wall of the housing may be shot-blasted and then plated or polished.

### BACKGROUND OF THE INVENTION

1 Technical Field of the Invention

The present invention relates generally to a gas sensor which may be installed in an exhaust system of an internal combustion engine for air-fuel ratio control. Particularly, the invention is directed to a method of producing an improved structure of a gas sensor designed to provide a hermetic seal which keeps a reference gas chamber and a gas chamber airtight and a product by such a production method.

2 Background Art

Gas sensors are know which are fabricated by inserting a sensor element into an insulation porcelain, mounting the insulation porcelain in a housing, installing a gas cover and an air cover on a front end and a base end of the housing, respectively, and sealing a gap between the insulation porcelain and the housing hermetically. This seal defines a gas chamber and an air chamber within the gas sensor.

The sensor element has a measuring electrode exposed to a gas to be measured and a reference electrode exposed to a reference gas or air and provides a signal in the form of an ion current flowing through the measuring and reference electrodes or a potential difference between the measuring and reference electrodes to determine the concentration of the gas. The leakage of the gas from the gas chamber to the air chamber will, thus, result in a decrease in accuracy of measuring the concentration of the gas. In order to avoid this problem, typical gas sensors pack powder material such as talc in the gap between the insulation porcelain and the housing to separate the gas chamber and the air chamber hermetically.

The use of powder material such as talc, however, encounters an economical disadvantage that the pressure required to pack the powder material and the amount of powder material must be controlled finely and precisely.

In order to alleviate such a drawback, bulk material-made packing is proposed as a sealing member. For example, U.S. Pat. No. 5,795,454 teaches a ceramic ring baked at lower temperature for sealing a gap between a sensor element and a housing to define a gas chamber and a reference gas chamber hermetically. The ceramic ring, however, usually remains having a certain degree of porosity even after the ceramic ring is installed under high pressure, which may result in lack of airtightness between the sensor element and the housing.

U.S. Pat. No. 5,795,454 also discloses use of a lower porosity metallic ring together with the ceramic ring for increasing the degree of the airtightness, however, it will result in increases in fabrication process and manufacturing cost. Moreover, the metallic ring may corrode early depending upon the type of a gas to be measured, which leads to a decrease in degree of the airtightness between the gas chamber and the reference gas chamber.

Therefore, a simple method of joining the insulation porcelain and the housing directly or using a sealing member such as a metal ring to provide a hermetic seal between the gas chamber and the reference gas chamber is sought.

### SUMMARY OF THE INVENTION

It is therefore a principal object of the invention to avoid the disadvantages of the prior art.

It is another object of the invention to provide to a method of producing an improved structure of a gas sensor designed to provide a hermetic seal which keeps a reference gas chamber and a gas chamber airtight and a product by such a production method.

According to the first aspect of the invention, there is provided a method of producing a housing of a gas sensor which is capable of providing a desired mechanical seal between a gas chamber and a reference gas chamber. The gas sensor includes a sensor element of a given length which consists of a first and a second portion and which is retained within the housing by a seat surface defined on a shoulder formed on an inner wall of the housing to hermetically define the reference gas chamber in which the first portion of the sensor element is exposed to a reference gas and the gas chamber in which the second portion of the sensor element is exposed to a gas to be measured. The method comprises the steps of: (a) preparing a hollow cylindrical metal block; (b) applying a lubricant to an inner wall of the metal block; (c) cold forging the metal block to form the inner wall into a desired shape; (c) removing the lubricant from the inner wall of the metal block using alkali and acid; and (d) machining an outer wall of the housing into a desired shape.

The removable of the lubricant from the inner wall of the metal block may be accomplished by degreasing the metal block with the alkali and then treating the metal block with the acid.

The treatment of the metal block with the acid may be accomplished by immersing the metal block in a solution of hydrochloric acid, rinsing the metal block with water, and immersing the metal block in a solution of nitric acid.

According to the second aspect of the invention, there is provided a method of producing a hollow cylindrical housing of a gas sensor including a sensor element of a given length which includes a first and a second portion and which is retained within the housing by a seat surface defined on a shoulder formed on an inner wall of the housing to hermetically define a first chamber in which the first portion of the sensor element is exposed to a reference gas and a second chamber in which the second portion of the sensor element is exposed to a gas to be measured. The method comprises the steps of: (a) preparing a hollow cylindrical metal block; (b) applying a lubricant to an inner wall of the metal block; (c) cold forging the metal block to form the inner wall into a desired shape; (d) machining the inner wall of the metal block to remove the lubricant therefrom; and (e) machining an outer wall of the housing into a desired shape.

According to the third aspect of the invention, there is provided a method of producing a hollow cylindrical housing of a gas sensor including a sensor element of a given length which includes a first and a second portion and which is retained within the housing by a seat surface defined on a shoulder formed on an inner wall of the housing to hermetically define a first chamber in which the first portion of the sensor element is exposed to a reference gas and a second chamber in which the second portion of the sensor element is exposed to a gas to be measured. The method comprises the steps of: (a) preparing a hollow cylindrical metal block; (b) applying a lubricant to an inner wall of the metal block; (c) cold forging the metal block to form the inner wall into a desired shape; (d) polishing the inner wall of the metal block to remove the lubricant therefrom; and (e) machining an outer wall of the housing into a desired shape.

According to the fourth aspect of the invention, there is provided a method of producing a hollow cylindrical housing of a gas sensor including a sensor element of a given length which includes a first and a second portion and which is retained within the housing by a seat surface defined on a shoulder formed on an inner wall of the housing to hermetically define a first chamber in which the first portion of the sensor element is exposed to a reference gas and a second chamber in which the second portion of the sensor element is exposed to a gas to be measured. The method comprises the steps of: (a) preparing a hollow cylindrical metal block; (b) applying a lubricant to an inner wall of the metal block; (c) cold forging the metal block to form the inner wall into a desired shape; (d) shot-blasting the inner wall of the metal block to remove the lubricant therefrom; (e) smoothing the inner wall of the metal block; and (f) machining an outer wall of the housing into a desired shape.

The smoothing step may plate the inner wall of the metal block after the lubricant is removed from the inner wall of the metal block.

The smoothing step may alternatively polish the inner wall of the metal block after the lubricant is removed from the inner wall of the metal block.

The sensor element may be retained by the seat surface of the housing through a packing member.

The gas sensor may include a cylindrical insulator which has a tapered shoulder formed on an outer wall thereof. The cylindrical insulator rests at the tapered shoulder on the seat surface of the housing to hold the sensor element within the housing.

The cylindrical insulator may rest on the seat surface of the housing through a packing member.

According to the fifth aspect of the invention, there is provided a gas sensor which comprises: (a) a hollow housing having a seat shoulder formed on an inner wall thereof; (b) a sensor element retained within the housing; (c) an air cover installed on a first end of the housing to define an air chamber filled with air to which a first portion of the sensor element is exposed; and (d) a gas cover installed on a second end of the housing to define a gas chamber filled with a gas to be measured to which a second portion of the sensor element is exposed. The seat surface of the housing has a ten-point average roughness of 6.3 μm or less.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor equipped with a housing made by an improved production method according to the first embodiment of the invention;

FIG. 2(a) is a plan view which shows a cylindrical metal block used to make the housing of FIG. 1;

FIGS. 2(b) and 2(c) are sectional views which show production processes to which the metal block of FIG. 2(a) is subjected;

FIG. 3 is a flowchart of a sequence of steps of removing lubricant from the metal block shown in FIGS. 2(b);

FIG. 4 is a longitudinal sectional view which shows a modification of the gas sensor of FIG. 1 in which a sealing assembly is provided for sealing a gap between a gas chamber and a reference chamber;

FIG. 5 is a longitudinal sectional view which shows another modification of the gas sensor of FIG. 1 in which a first insulation porcelain rests directly on an inner shoulder of a housing to provide a hermetic seal between a gas chamber and a reference chamber;

FIG. 6 is a longitudinal sectional view which shows the third modification of the gas sensor of FIG. 1 in which a powder sealing member is provided between an inner wall of a housing and an outer wall of a sensor element;

FIG. 7 is a graph which shows the quantity of lubricant remaining on a surface of a metal block of FIGS. 2(b), the air leakage between a gas chamber and a reference gas chamber, and the surface roughness of a seat surface of a housing;

FIG. 8 is a view which shows a leakage test device;

FIG. 9 is a longitudinal sectional view which shows a gas sensor according to the second embodiment of the invention;

FIG. 10 is a longitudinal sectional view which shows a gas sensor according to the third embodiment of the invention; and

FIG. 11 is a longitudinal sectional view which shows a gas sensor according to the second embodiment of the invention.

### DESCRIPTION OF THE PREFERRED EMBODIMENTS

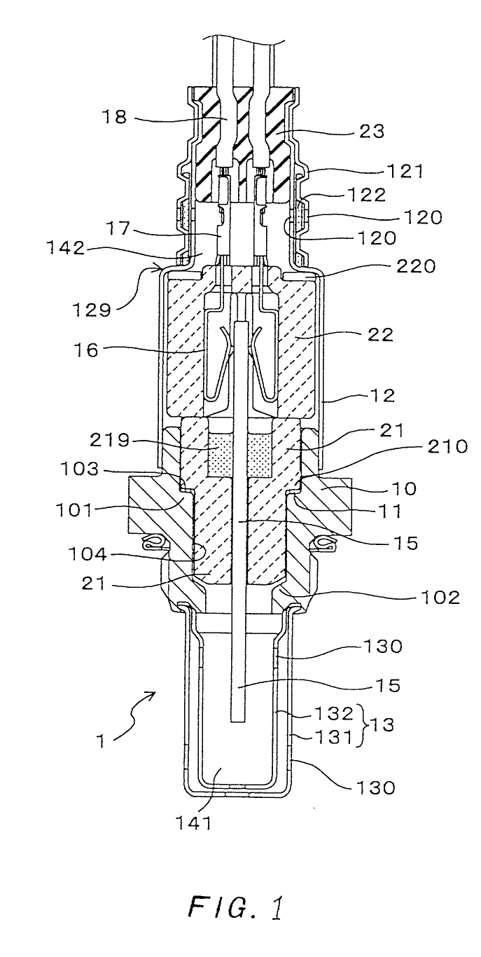

Referring to the drawings, wherein like reference numbers refer to like parts in several views, particularly to FIG. 1, there is shown a gas sensor 1 according to the first embodiment of the invention which may be employed in an air-fuel ratio control system for automotive vehicles to measure the concentration of a component such as NOx, CO, HC, or 0₂ contained in exhaust gasses of the engine.

The gas sensor 1 generally includes a sensor element 15, a first insulation porcelain 21, a second insulation porcelain 22, a hollow cylindrical housing 10, and an air cover 12. The sensor element 15 is made of a laminated plate. U.S. Pat. No. 5,573,650, issued on Nov. 12, 1996 to Fukaya et al. teaches a typical laminated sensor element, disclosure of which is incorporated herein by reference. The first insulation porcelain 21 is fitted within the housing 10 and holds therein the sensor element 15 through a glass sealing member 219. The first insulation porcelain 21 has an annular tapered surface 210 which rests on a seat surface 103 formed on an inner wall 104 of the housing 10. The second insulation porcelain 22 is mounted on the first insulation porcelain 21 and surrounds a base portion of the sensor element 15. The air cover 12 is installed at an end thereof on the housing 10 and surrounds the second insulation porcelain 22 to define an air chamber 142. The air chamber 142 is filled with air used as a reference gas to which the base portion of the sensor element 15 is exposed.

The second insulation porcelain 22 is made of a hollow cylindrical insulating member and has disposed therein four leads 16 (only two are shown for the simplicity of illustration) each of which is made of a wire folded elastically to make an electric contact at one end with an electrode terminal (not shown) formed on the sensor element 15. The leads 16 extend at the other end through holes formed in an end of the second insulation porcelain 22 and connect with four leads 18 through connectors 17, respectively, for transmission of sensor signals between the sensor element 15 and an external device and supply of electric power to a heater installed on the sensor element 15.

The gas sensor 1 also includes a double-walled protective cover assembly 13 consisting of an outer cover 131 and an inner cover 132. The protective cover assembly 13 is installed in a head of the housing 10 to define a gas chamber 141 into which a gas to be measured is admitted through gas holes 130 formed in the outer and inner covers 131 and 132. The head portion of the sensor element 15 is exposed to the gas in the gas chamber for outputting a sensor signal as a function of the concentration of the gas from the electrodes of the sensor element 15. This operation is well known in the art, and explanation thereof in detail will be omitted here.

The air cover 12 is, as described above, fitted on the base end of the housing 10. An outer cover 121 is provided around the air cover 12 and staked or crimped to retain a water-repellent filter 122 on the periphery of the air cover 12. The air cover 12 and the outer cover 121 have formed therein air vents 120 through which air (i.e., the reference gas) is admitted into the air chamber 142. The air cover 12, as clearly shown in FIG. 1, has a shoulder 129 to define a small-diameter portion and a large-diameter portion. A disc spring 220 is disposed between the shoulder 129 and an end of the second insulation porcelain 22 to elastically urge the second insulation porcelain 22 into constant engagement with the first insulation porcelain 21 to increase the degree of airtightness provided by a metal packing ring 11. An insulating holder 23 made of rubber is disposed inside the small-diameter portion of the air cover 12. The metal packing ring 11 is made of a pure nickel of a 99% purity containing a small amount of impurities such as cobalt etc. The metal packing ring 11, therefore, has a highly dense surface which ensures a high degree of airtightness between the second insulation porcelain 21 and the housing 10. The metal packing ring 11 may alternatively be made of a nickel alloy, a titanium, a stainless steel, or a mixture of at least two of them (including a pure nickel) in terms of the durability.

The housing 10 is made of a hollow cylinder and has two annular shoulders 101 and 102 formed on an inner wall thereof. The shoulder 101 has the seat surface 103 on which the tapered surface 210 of the first insulation porcelain 21 rests through the metal packing ring 11 to provides a hermetic seal between the air chamber 142 and the gas chamber 141.

The sensor element 15, as described above, has a heater built therein which heats the sensor element 15 up to a temperature required for the sensor element 15 to be sensitive to a gas to be measured correctly. The sensor element 15 has formed thereon four electrode terminals two of which are used for outputting sensor signals and the others for supply of electric power to the heater. The electrode terminals are connected electrically with ends of the leads 16 in an illustrated manner, respectively. The leads 16 extend through the holes formed in the end wall of the second insulation porcelain 22 and are inserted into the connectors 17, respectively. The connectors 17 are coupled with the leads 18 retained in holes formed in the insulating holder 23. This structure is not essential part of this invention and known in the art, and explanation thereof in detail will be omitted here.

The production of the housing 10 is accomplished in the following manner.

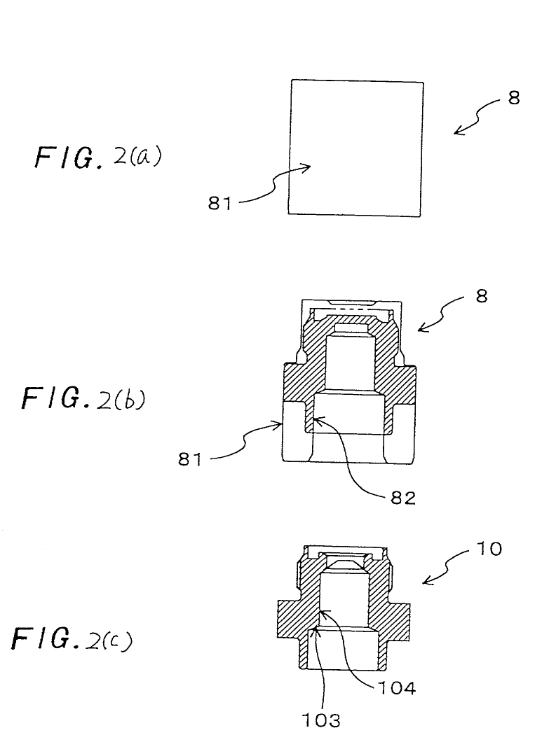

First, a solid cylindrical metal block 8, as shown in FIG. 2(a), is prepared. The cylindrical metal block 8 is machined to chamfer an outer wall 81 and swaged into a shape substantially similar to the housing 10.

Next, the cylindrical block 8 is degreased to clean grease or oil from the outer wall 81. Subsequently, lubricant is applied to an inner wall 82 of the cylindrical metal block 8 in the following manner for avoiding the seizure in following cold forging.

In order to facilitate ease of adhesion of the lubricant to the inner wall 82 of the cylindrical metal block 8, the inner wall 82 is shot-blasted for 20 minutes using steel balls of 0.8 mm in diameter.

Next, the cylindrical metal block 8 is put in a basket and then in a vessel containing chemicals such as celonize 100A and 100B (produced by Kiwa Chemistry in Japan). The cylindrical block 8 is dipped in the chemical at 90° C. for 20 minutes to form an oxalate coating of 7 to 17 g in weight per 1 m².

Subsequently, the cylindrical metal block 8 is washed off with water and then rinsed with hot water of 80° C. for five minutes.

The cylindrical metal block 8 is dipped in a water soluble oil containing a solid lubricant (MoS₂) prepared in a vessel at 70° C. for five minutes. The solid lubricant is used as the lubricant as described above. The cylindrical metal block 8 is dried using a hot blast heater at 70 to 80° C. for ten minutes.

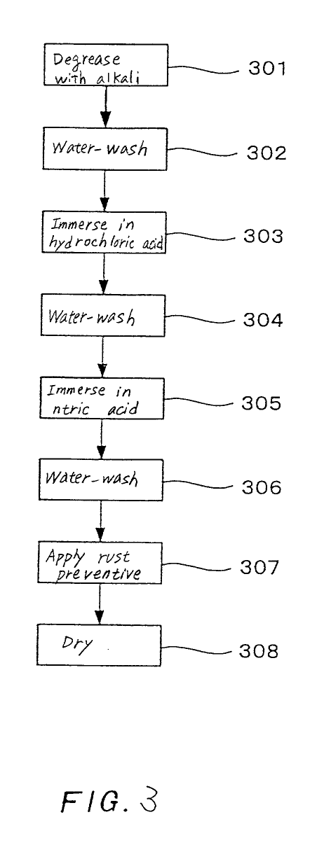

The cylindrical metal block 8 is cold forged with a vertical single impact to finish the inner wall 82 to a desired shape. The lubricant is removed from the cylindrical metal block 8 using alkali and acid agents. This process will be discussed below in detail using a flowchart of FIG. 3.

First, in step 301, the cylindrical metal block 8 is degreased using an alkali solution having a content of 3 to 10% Gildaon ES3300 (produced by Central Chemistry Co. Ltd.) which includes sodium hydroxide, orthosodium silicate, polymerized sodium phoshate, sodium carbonate, etc. The degreasing is accomplished by immersing the cylindrical metal block 8 in the alkali solution at 60±10° C. for 5±3 minutes. The alkali solution may be prepared using a single kind of sodium depending upon the type of the lubricant.

In step 302, the cylindrical metal block 8 is rinsed with water to remove the degreasing agent used in step 301.

In step 303, the cylindrical metal block 8 is immersed in a solution of hydrochloric acid at 40 to 45° C. for 1±0.2 minutes, thereby removing a thin coating from the surface of the cylindrical metal block 8. The solution concentration is in the range of 400±50 cc/liter.

In step 304, the cylindrical metal block 8 is water washed to remove the hydrochloric acid.

In step 305, the cylindrical metal block 8 is immersed in a solution of nitric acid at 40 to 45° C. for 1±0.2 minutes, thereby removing the lubricant. The nitric acid concentration is in the range of 100±20 cc/liter. The solution also has a content of 5±2 g/liter ammonium hydrogenfluoride.

In step 306, the cylindrical metal block 8 is rinsed with water to remove the solution of nitric acid.

In step 307, a rust preventive is applied to the whole surface of the cylindrical metal block 8.

In step 308, the cylindrical metal block 8 is dried and cur or machined, as shown in FIGS. 2(b) and 2(c), to a desired shape to complete the housing 10. In FIG. 2(b), a white portion indicates a portion of the meta block 8 to be removed by the cutting or machining.

The housing 10 made in the above manner has a surface roughness of 6.3 μg or less on the seat surface 103 which is expressed by taking an average of ten samples measured at ten points on the seat surface 103, thereby establishing a desired hermetic seal between the inner wall of the housing 10 and the outer wall of the first insulation porcelain 21.

The fabrication of the gas sensor 1 is accomplished in the following manner.

The second insulation porcelain 22 in which the leads 16 are disposed in electric communication with the leads 18 and the electrodes on the sensor element 15 is inserted into the air cover 12 together with the disc ring 220. The housing 10 within which the first insulation porcelain 21 is installed is fitted in the opening of the second insulation porcelain 22 while pressing the second insulation porcelain 22 against the shoulder 129 of the air cover and welded at a side wall thereof to the air cover 12.

During the fitting of the housing 10 in the air cover 12, the metal packing ring 11 is pressed by the first insulation porcelain 21 against the seat surface 103 of the housing 10, so that it is deformed elastically following the shape of the end of the first insulation porcelain 21 and the seat surface 103, thereby providing an airtight seal between the air chamber 142 and the gas chamber 141.

In the production of the housing 10, the lubricant is, as described above, removed from the cylindrical metal block 8 using the alkali and acid agents, so that the cylindrical metal block 8 is cleaned without forming irregularities on the inner wall 82 of the housing 8, thereby enabling the inner wall 82 to have a smooth surface whose surface roughness of 3 μm. This allows the first insulation porcelain 21 to be fitted in the housing 10 without any gap, thus establishing a hermetic seal therebetween.

We made a housing in a manner in which the lubricant is removed by shot blasting instead of the alkali and acid agents in the process of FIG. 3. The surface roughness of the housing was about 50 μm. The removal of the lubricant using the alkali and acid agents is usually simple and controlled easily, thus resulting in a decrease in manufacturing cost of the housing 10.

In the production of the housing 8, the oxalate coating and the MoS₂ coating are formed on the inner wall 82 of the cylindrical metal block 8 The cylindrical metal block 8 is, as described above, degreased using the alkali agent and then immersed in the solution of hydrochloric acid, so that the oxalate coating is removed. Afterward, the cylindrical metal block 8 is immersed in the nitric acid solution, so that the nitric acid that is a strong acid works to etch the inner surface of the cylindrical metal block 8 to remove the MoS₂ coating physically. Specifically, MoS₂ is refractory. The MoS₂ coating is, thus, peeled physically by dissolving the inner surface of the cylindrical metal block 8.

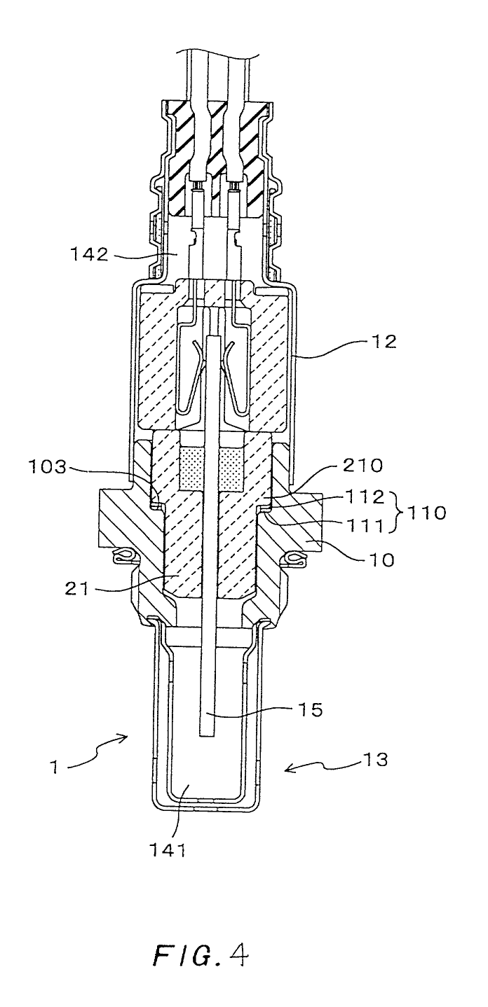

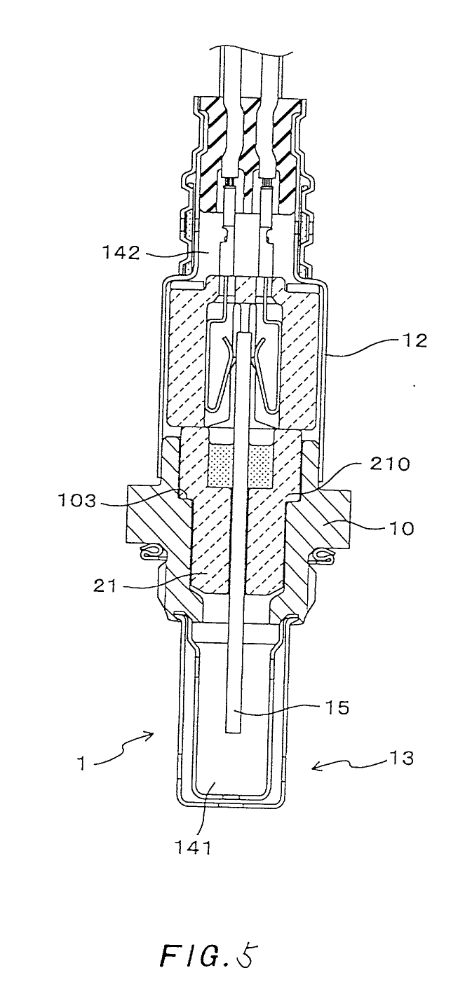

While the gas sensor 1 of FIG. 1 has, as described above, the metal packing ring 11 disposed between the seat surface 103 and the tapered surface 210 of the first insulation porcelain 21, a metal packing assembly 110, as shown in FIG. 4, made up of two rings laid to overlap each other may alternatively be used. Further, the first insulation porcelain 21 may alternatively be, as shown in FIG. 5, placed at the tapered surface 210 directly on the seat surface 103.

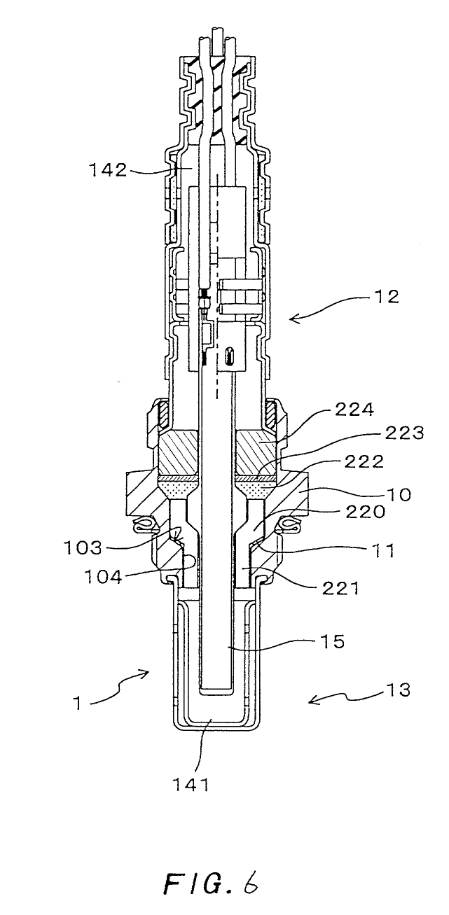

This embodiment may also be used with a gas sensor 1 shown in FIG. 6. The gas sensor 1 has an insulation porcelain 221. The insulation porcelain 221 has formed thereon a tapered shoulder 220 which rests on the seat surface 103 of the housing 10 through the metal packing ring 11. A powder sealing member 222 made of talc, a sealing member 223, and an insulator 224 are disposed on an end of the insulation porcelain 221 within the housing 10.

Tests performed by the inventors of this application in terms of removal of the lubricant, the surface roughness of the housing 10, and the degree of airtightness of the gas sensor 1 will be discussed below.

Five test gas sensors equipped with housing samples No. 1 to No. 5 were prepared.

The test gas sensors all have the same structure as the one shown in FIG. 1. In the tests, conditions for treating the lubricant after the housing samples were cold forged were changed.

The housing sample No. 1 was cold forged, after which the outer surface thereof was machined. The housing sample No. 1 was built into the gas sensor, with lubricant left on the inner wall thereof.

The housing samples No. 2 to No. 5 were degreased using an alkali agent under the same condition as that in the above described embodiment.

The housing samples No. 2 to No. 5 were also water-washed and immersed in a solution of hydrochloric acid under substantially the same conditions as those in the above embodiment. Specifically, the housing sample No. 2 was immersed in an aqueous solution having a content of 400 cc/liter hydrochloric acid at 45° C. The housing sample No. 3 was immersed in an aqueous solution having a content of 300 cc/liter hydrochloric acid. The housing sample No. 4 was immersed in an aqueous solution having a content of 500 cc/liter hydrochloric acid. The housing sample No. 5 was immersed in an aqueous solution having a content of 400 cc/liter hydrochloric acid.

After treated with the aqueous solution of hydrochloric acid, the housing sample No. 2 was water-washed and then immersed in an aqueous solution of nitric acid at 45° C. for 1 minute. The nitric acid concentration was 100 cc/liter. The aqueous solution also had a content of 5 g/liter hydrogen fluoride.

The housing sample No. 3 was treated with nitric acid under the same condition as that of the housing sample No. 2.

The housing sample No. 4 were not treated with nitric acid.

The housing sample No. 5 was immersed in an aqueous solution of nitric acid at 45° C. for 1 minute. The nitric acid concentration was 250 cc/liter. The aqueous solution also had a content of 30 g/liter hydrogen fluoride.

After treated with nitric acid, each of the housing samples No. 1 to No. 5 was, like the above embodiment, water-washed, applied with a rust preventive, and dried.

Other treatments to which the housing samples No. 1 to No. 5 were subjected were the same as those in the above embodiment.

The residual quantity of the lubricant remaining on the housing samples No. 1 to No. 5 were determined by measuring contents of S and Mo through the X-ray fluorescence analysis. The X-ray fluorescence analysis was made using a Shimazu XRF-1500. A beam diameter was φ3. Contents of S and Mo of a metal material of each of the housing samples No. 1 to No. 5 were measured before they were cold forged for correction in measuring the residual quantity of the lubricant.

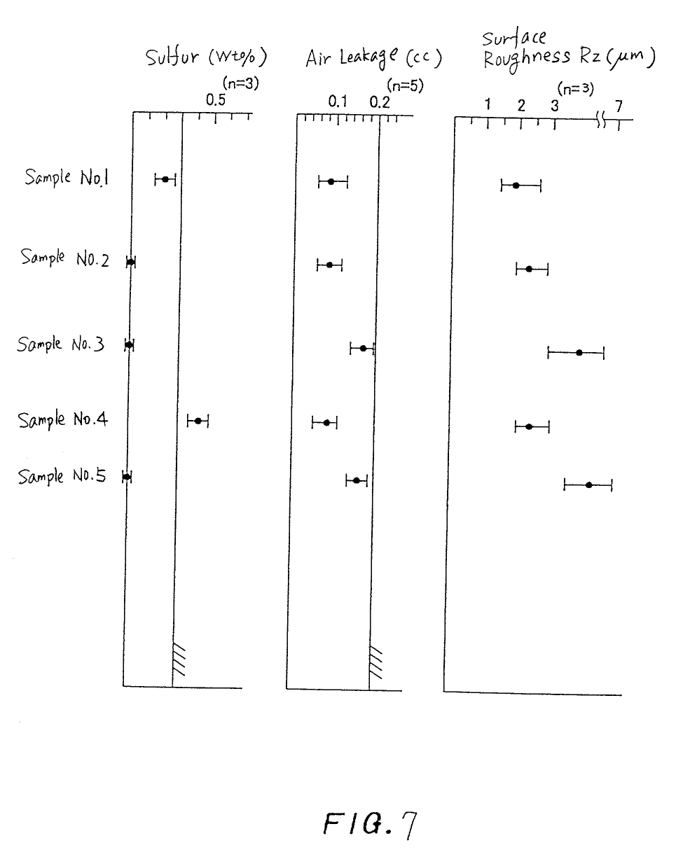

The residual quantity of the lubricant is expressed in quantity of S (Sulfur), which is a main component of the lubricant, contained in a surface of each of the housing samples No. 1 to No. 5. The measurement of the residual quantity of the lubricant were performed three times. Results thereof are shown in FIG. 7. In FIG. 7, n indicates the number of samples.

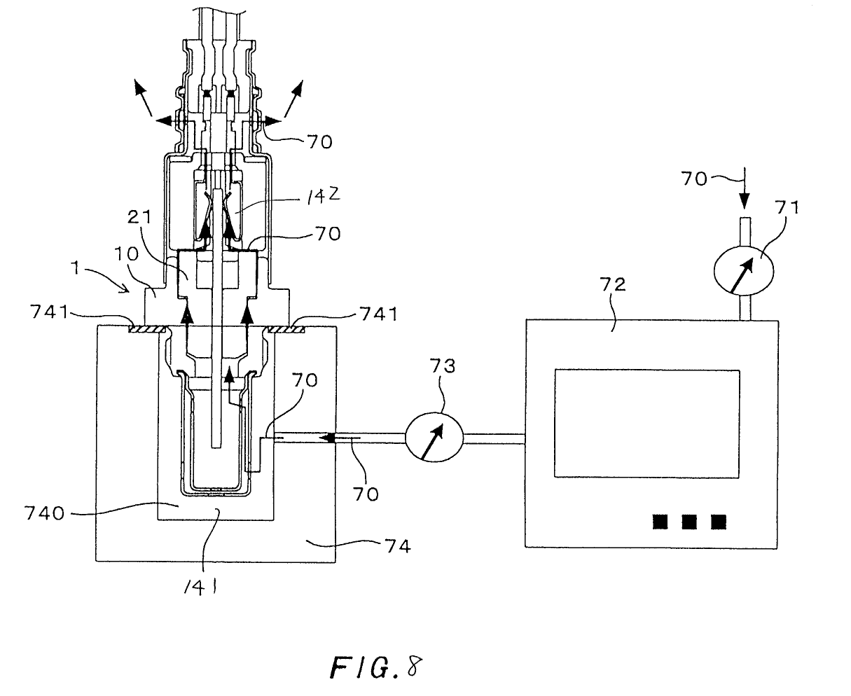

Additionally, leakage tests were performed on the test gas sensors equipped with the housing samples No. 1 to No. 5 using a test device as shown in FIG. 8.

The test device includes a leakage measuring unit 72 equipped with an air regulator valve 71 and a gas sensor mount base 74. The leakage measuring unit 72 and the gas sensor mount base 74 are connected through a valve 73. The head of each of the test gas sensors is installed in an air cavity 740 of the gas sensor mount base 74 hermetically through a rubber seal 741.

10 minutes after the air 70 was supplied to the air cavity 740 at 4 atm., a drop in pressure in the air cavity 740 was measured to determine the amount of air (cc/min) leaking from the gas chamber 141 to the air chamber 142. This measurement was performed five times. The results of the measurements are shown in the graph of FIG. 7. Note that a gap between the sensor element 15 and the first insulation porcelain 21 is sealed by a glass sealing member, so that the air leakage therefrom may be ignored.

Further, the roughness of the seat surface 103 of each of the housing samples No. 1 to No. 5 was measured. This measurement was made three times over a length of 0.8 mm in accordance with JISB0601 using a needle whose tip angle is 90° and radius of curvature at the tip is 2 μm. The results of the measurements are shown in the graph of FIG. 7. Each result is expressed by an average of values measured at three random points.

The graph of FIG. 7 shows that the housing samples No. 1 to No. 5 all have small values of the surface roughness so that air leakage in each test gas sensor is low. However, the housing samples No. 1 and No. 4, as can be seen from FIG. 7, have a relatively great content of S, so that they are low in durability, which may result in decrease in performance of the gas sensor.

The housing sample No. 4, as described above, were not treated with nitric acid. The oxalate coating may, thus, be thought of as removed, however, the MoS₂ coating may be thought of as left on the housing sample No. 4. Accordingly, it is found that after treated with alkali, the metal block 8 shown in FIG. 8 used to make the housing 10 is preferably treated with hydrochloric acid and nitric acid under the same conditions as those in the housing sample No. 2 to remove the lubricant.

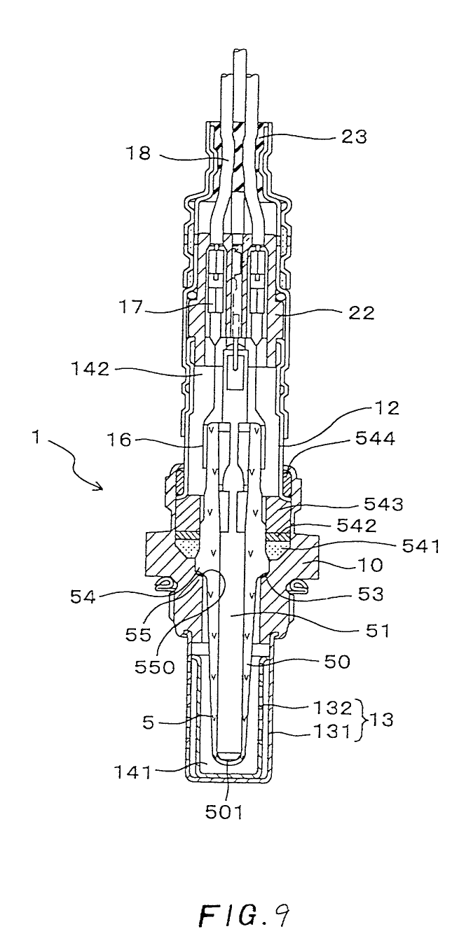

FIG. 9 shows a gas sensor 1 according to the second embodiment of the invention which is equipped with a housing 10 made in the above described manner.

The gas sensor 1 has a cup-shaped sensor element 5 fitted in the housing 10. The sensor element 15 includes a solid electrolyte body 50 which has an air chamber 501 with which a bar type heater 51 is disposed. The solid electrolyte body 50 has an electrodes (not shown) formed on inner and outer walls thereof.

The housing 10 has an annular shoulder 55 formed on an inner wall thereof which has a seat surface 550 on which a tapered shoulder 54 formed on an outer wall of the sensor element 5 rests through a metal packing ring 53.

A powder sealing member 541, a packing ring 542, and an annular insulator 543 are disposed around the sensor element 5 within the housing 10. An end of the air cover 12 is put in an open end of the housing 10 and secured tightly by curving the end of the housing 10 inwardly to press the end of the air cover 12 elastically through a metal ring 544 against an edge portion of the insulator 543, thereby providing a hermetic sea between the inner wall of the housing 10 and the outer wall of the sensor element 5.

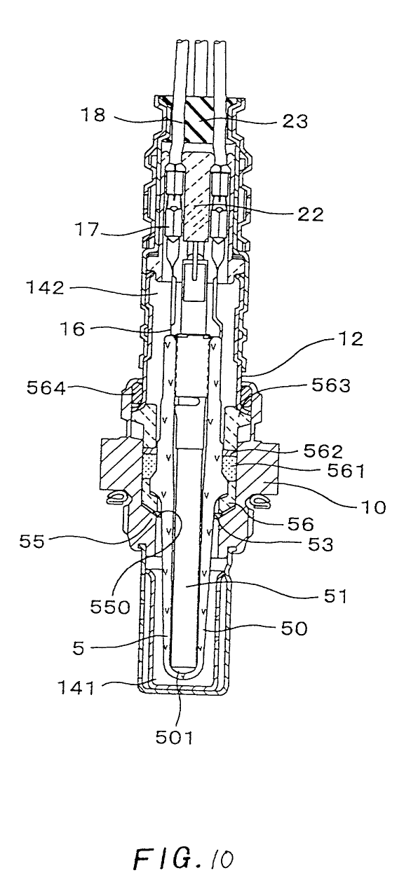

FIG. 10 shows a gas sensor 1 according to the third embodiment of the invention which is equipped with a housing 10 made in the above described manner.

The cup-shaped sensor element 5 is disposed within the housing 10 through an annular insulator 563. An annular insulator 56 rests at an edge thereof on a seat surface 550 of an annular shoulder 55 formed on an inner wall of the housing 10 through a metal packing ring 53. A powder sealing member 561, a packing ring 562, and the annular insulator 563 are disposed on the insulator 56. An end of the air cover 12 is put in an open end of the housing 10 and secured tightly by curving the end of the housing 10 inwardly to press the end of the air cover 12 elastically through a metal ring 564 against an edge portion of the insulator 563, thereby providing a hermetic sea between the inner wall of the housing 10 and the outer wall of the sensor element 5 to define the gas chamber 141 and the air chamber 142 in an airtight fashion.

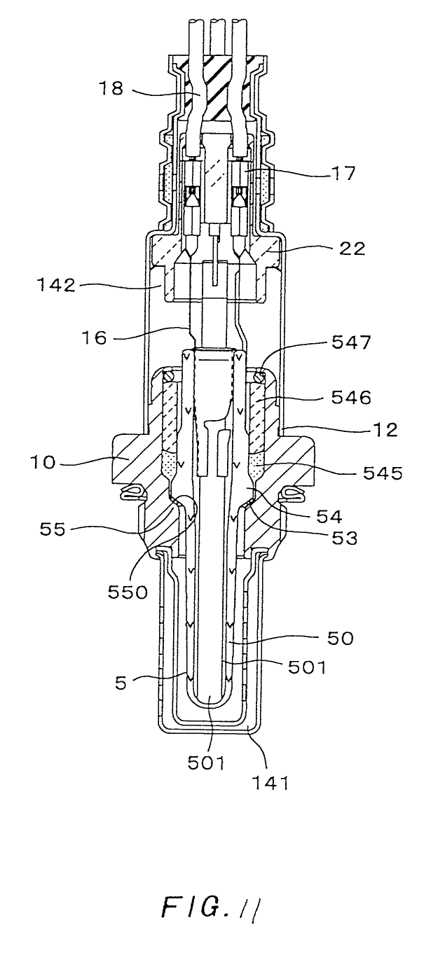

FIG. 11 shows a gas sensor 1 according to the fourth embodiment of the invention which is equipped with a housing 10 made in the above described manner.

The cup-shaped sensor element 5 rests at a tapered shoulder 54 thereof on a seat surface 550 of an annular shoulder 55 formed on an inner wall of the housing 10 through a metal packing ring 53. A powder sealing member 545 and a cylindrical insulator 546 are disposed on the annular shoulder 5 of the housing 10. An open end of the housing 10 is pressed inwardly to urge an end of the cylindrical insulator 546 elastically through a metal ring 547, thereby providing a hermetic seal between the outer wall of the sensor element 5 and the inner wall of the housing 10 to define the gas chamber 141 and the air chamber 142 in an airtight fashion.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims. For example, as an alternative to removing the lubricant from the metal block 8 in FIG. 2(b), the inner wall of the metal block 8 may be cut or machined, ground, or polished to provide a smooth surface. Additionally, the inner wall of the metal block 8 may also be shot-blasted and then subjected to a smoothing process such as plating or polishing.

What is claimed is:

1. A method of producing a hollow cylindrical housing of a gas sensor including a sensor element of a given length which includes a first and a second portion and which is retained within the housing by a seat surface defined on a shoulder formed on an inner wall of said housing to hermetically define a first chamber in which the first portion of said sensor element is exposed to a reference gas and a second chamber in which the second portion of said sensor element is exposed to a gas to be measured, said method comprising the steps of:
preparing a hollow cylindrical metal block;
applying a lubricant to an inner wall of said metal block;
cold forging said metal block to form the inner wall into a desired shape;
removing the lubricant from the inner wall of said metal block using alkali and acid; and
machining an outer wall of said housing into a desired shape.

2. A method as set forth in claim 1, wherein the removable of the lubricant from the inner wall of said metal block is accomplished by degreasing said metal block with the alkali and then treating said metal block with the acid.

3. A method as set forth in claim 2, wherein treatment of said metal block with the acid is accomplished by immersing said metal block in a solution of hydrochloric acid, rinsing said metal block with water, and immersing said metal block in a solution of nitric acid.

4. A method as set forth in claim 1, wherein the sensor element is retained by the seat surface of said housing through a packing member.

5. A method as set forth in claim 1, wherein the gas sensor includes a cylindrical insulator which has a tapered shoulder formed on an outer wall thereof, the cylindrical insulator resting at the tapered shoulder on the seat surface of said housing to hold the sensor element within said housing.

6. A method as set forth in claim 5, wherein the cylindrical insulator rests on the seat surface of said housing through a packing member.

7. A method of producing a hollow cylindrical housing of a gas sensor including a sensor element of a given length which includes a first and a second portion and which is retained within the housing by a seat surface defined on a shoulder formed on an inner wall of said housing to hermetically define a first chamber in which the first portion of said sensor element is exposed to a reference gas and a second chamber in which the second portion of said sensor element is exposed to a gas to be measured, said method comprising the steps of:
preparing a hollow cylindrical metal block;
applying a lubricant to an inner wall of said metal block;
cold forging said metal block to form the inner wall into a desired shape;
machining the inner wall of said metal block to remove the lubricant therefrom; and
machining an outer wall of said housing into a desired shape.

8. A method as set forth in claim 7, wherein the sensor element is retained by the seat surface of said housing through a packing member.

9. A method as set forth in claim 7, wherein the gas sensor includes a cylindrical insulator which has a tapered shoulder formed on an outer wall thereof, the cylindrical insulator resting at the tapered shoulder on the seat surface of said housing to hold the sensor element within said housing.

10. A method as set forth in claim 9, wherein the cylindrical insulator rests on the seat surface of said housing through a packing member.

11. A method of producing a hollow cylindrical housing of a gas sensor including a sensor element of a given length which includes a first and a second portion and which is retained within the housing by a seat surface defined on a shoulder formed on an inner wall of said housing to hermetically define a first chamber in which the first portion of said sensor element is exposed to a reference gas and a second chamber in which the second portion of said sensor element is exposed to a gas to be measured, said method comprising the steps of:
preparing a hollow cylindrical metal block;
applying a lubricant to an inner wall of said metal block;
cold forging said metal block to form the inner wall into a desired shape;
polishing the inner wall of said metal block to remove the lubricant therefrom; and
machining an outer wall of said housing into a desired shape.

12. A method as set forth in claim 11, wherein the sensor element is retained by the seat surface of said housing through a packing member.

13. A method as set forth in claim 11, wherein the gas sensor includes a cylindrical insulator which has a tapered shoulder formed on an outer wall thereof, the cylindrical insulator resting at the tapered shoulder on the seat surface of said housing to hold the sensor element within said housing.

14. A method as set forth in claim 13, wherein the cylindrical insulator rests on the seat surface of said housing through a packing member.

15. A method of producing a hollow cylindrical housing of a gas sensor including a sensor element of a given length which includes a first and a second portion and which is retained within the housing by a seat surface defined on a shoulder formed on an inner wall of said housing to hermetically define a first chamber in which the first portion of said sensor element is exposed to a reference gas and a second chamber in which the second portion of said sensor element is exposed to a gas to be measured, said method comprising the steps of:
preparing a hollow cylindrical metal block;
applying a lubricant to an inner wall of said metal block;
cold forging said metal block to form the inner wall into a desired shape;
shot-blasting the inner wall of said metal block to remove the lubricant therefrom;
smoothing the inner wall of said metal block; and
machining an outer wall of said housing into a desired shape.

16. A method as set forth in claim 15, wherein said smoothing step plates the inner wall of said metal block after the lubricant is removed from the inner wall of said metal block.

17. A method as set forth in claim 15, wherein said smoothing step polishes the inner wall of said metal block after the lubricant is removed from the inner wall of said metal block.

18. A method as set forth in claim 17, wherein the sensor element is retained by the seat surface of said housing through a packing member.

19. A method as set forth in claim 15, wherein the gas sensor includes a cylindrical insulator which has a tapered shoulder formed on an outer wall thereof, the cylindrical insulator resting at the tapered shoulder on the seat surface of said housing to hold the sensor element within said housing.

20. A method as set forth in claim 19, wherein the cylindrical insulator rests on the seat surface of said housing through a packing member.

21. A gas sensor comprising:
a hollow housing having a seat shoulder formed on an inner wall thereof;
a sensor element retained within said housing;
an air cover installed on a first end of said housing to define an air chamber filled with air to which a first portion of said sensor element is exposed; and
a gas cover installed on a second end of said housing to define a gas chamber filled with a gas to be measured to which a second portion of said sensor element is exposed,
wherein the seat surface of said housing has a ten-point average roughness of 6.3 μm or less.
